(19) United States
(12) Patent Application Publication
(10) Pub. No.: US 2016/0372235 A1
(43) Pub. Date: Dec. 22, 2016

(54) HIGH-SPEED TRANSMISSION CABLE AND METHOD OF MANUFACTURING THE SAME

(71) Applicant: Hitachi Metals, Ltd., Tokyo (JP)

(72) Inventors: Takahiro SUGIYAMA, Hitachi (JP); Hideyuki SUZUKI, Hitachi (JP)

(21) Appl. No.: 15/176,497

(22) Filed: Jun. 8, 2016

(30) Foreign Application Priority Data
Jun. 16, 2015 (JP) 2015-120834

(51) Int. Cl. H01B 11/06; H01B 13/22; H01B 13/06

(52) U.S. Cl. CPC H01B 11/06; H01B 13/06; H01B 13/22

(57) ABSTRACT

A high-speed transmission cable includes two parallel signal lines for transmitting a differential signal, an insulation collectively covering the two signal lines, a shield conductor covering the insulation, and a ground connecting drain wire. The drain wire is arranged so that a portion of the outer circumference thereof covered with the insulation is held by the insulation, another portion of the outer circumference not covered with the insulation protrudes outward from the insulation and the protruding portion is electrically in contact with the shield conductor.

The present application is based on Japanese patent application No. 2015-120834 filed on Jun. 16, 2015, the entire contents of which are incorporated herein by reference.

### BACKGROUND OF THE INVENTION

### 1. Field of the Invention

The invention relates to a high-speed transmission cable and a method of manufacturing the high-speed transmission cable.

### 2. Description of the Related Art

In servers, routers and data storage products, etc., which operate with high-speed digital signals of not less than several Gbps, differential signals are transmitted between electronic devices or between circuit boards inside an electronic device.

A high-speed transmission cable having a two-cores-in-one-cover structure (a structure in which two cores are housed in one cover) is known as a conventional high-speed transmission cable for transmitting a differential signal and is provided with two parallel signal lines (signal conductors) for transmitting a differential signal, an insulation collectively covering the two signal lines, and a shield conductor provided to cover the insulation.

Another high-speed transmission cable, which has a two-cores-in-one-cover but is provided with a ground connecting drain wire and is easily connected to a member provided on a terminal of a circuit board, etc., has been also proposed.

A high-speed transmission cable disclosed in, e.g., the specification of U.S. Pat. No. 7,999,185 has a structure in which a member formed by covering a drain wire with an insulation is provided separately from a core formed by covering two signal lines with an insulation, and this member and the core are covered with a shield conductor. U.S. Pat. No. 7,999,185 also discloses that the drain wire is partially exposed from the insulation and the shield conductor is provided in contact with the exposed portion and is thereby electrically connected to the drain wire.

Meanwhile, JP-B-5141660 and JP-A-2003-297154 disclose high-speed transmission cables having a structure in which an insulation covering two signal lines and a drain wire arranged in a groove formed on the insulation are covered with a shield conductor.

### SUMMARY OF THE INVENTION

The high-speed transmission cable described in U.S. Pat. No. 7,999,185 is not easy to manufacture since the member formed by covering a drain wire with an insulation is provided separately from the core formed by covering two signal lines with an insulation and this increases the number of components. In addition, since it is configured so that the surface of the exposed portion of the drain wire is flush with the surface of the insulation, the drain wire may not be reliably in contact with the shield conductor when a manufacturing error, etc., occurs. Furthermore, since a large gap is formed between the shield conductor and the core and between the shield conductor and the member formed by covering a drain wire with an insulation, electrical characteristics may degrade due to the gap.

The high-speed transmission cables in JP-B-5141660 and JP-A-2003-297154 are also not easy to manufacture since the drawn wire arranged in the groove formed on the core is not configured to be fixed to the groove and it takes time and effort to provide a shield conductor especially when plural drain wires are arranged. The high-speed transmission cables in JP-B-5141660 and JP-A-2003-297154 also have problems that a large gap is likely to be formed between the insulation and the shield conductor due to the drain wire and electrical characteristics are likely to degrade.

It is an object of the invention to provide a high-speed transmission cable that has good electrical characteristics and is easy to manufacture, as well as a method of manufacturing the high-speed transmission cable.

According to an embodiment of the invention, a high-speed transmission cable comprises:

two parallel signal lines for transmitting a differential signal;

an insulation collectively covering the two signal lines;

a shield conductor covering the insulation; and

a ground connecting drain wire,

wherein the drain wire is arranged so that a portion of the outer circumference thereof covered with the insulation is held by the insulation, another portion of the outer circumference not covered with the insulation protrudes outward from the insulation and the protruding portion is electrically in contact with the shield conductor.

According to another embodiment of the invention, a method of manufacturing a high-speed transmission cable comprises:

covering two parallel signal lines for transmitting a differential signal and a ground connecting drain wire with an insulation;

removing a portion of the insulation so that a portion of the outer circumference of the drain wire protrudes outwards from the insulation; and

providing a shield conductor to cover the insulation so that the shield conductor is electrically in contact with the protruding portion of the drain wire.

According to another embodiment of the invention, a method of manufacturing a high-speed transmission cable comprises:

covering two parallel signal lines for transmitting a differential signal and a dummy wire with an insulation;

removing a portion of the insulation and taking the dummy wire out from the insulation;

fitting a ground connecting drain wire into a recess on the insulation produced by taking out the dummy wire so that the drain wire is held by the insulation and a portion of the outer circumference of the drain wire protrudes outwards from the insulation; and

providing a shield conductor to cover the insulation so that the shield conductor is electrically in contact with the protruding portion of the drain wire.

### Effects of the Invention

According to an embodiment of the invention, a high-speed transmission cable can be provided that has good electrical characteristics and is easy to manufacture, as well as a method of manufacturing the high-speed transmission cable.

### BRIEF DESCRIPTION OF THE DRAWINGS

Next, the present invention will be explained in more detail in conjunction with appended drawings, wherein:

FIG. 1 is a cross sectional view showing a high-speed transmission cable in an embodiment of the present invention;

FIGS. 2A to 2D are illustration diagrams showing a method of manufacturing the high-speed transmission cable in the embodiment of the invention;

FIGS. 3A to 3F are illustration diagrams showing a method of manufacturing the high-speed transmission cable in the embodiment of the invention;

FIGS. 4A to 4C are illustration diagrams showing a method of manufacturing the high-speed transmission cable in the embodiment of the invention;

FIG. 5 is a cross sectional view showing a high-speed transmission cable in a modification of the invention; and

FIG. 6 is an illustration diagram showing a method of manufacturing the high-speed transmission cable in a modification of the invention.

### DETAILED DESCRIPTION OF THE PREFERRED EMBODIMENTS

### Embodiment

An embodiment of the invention will be described below in conjunction with the appended drawings.

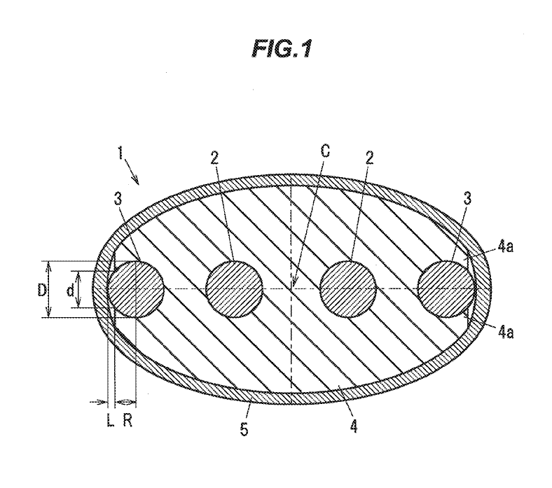

FIG. 1 is a cross sectional view showing a high-speed transmission cable in the present embodiment.

As shown in FIG. 1, a high-speed transmission cable 1 is provided with two parallel signal lines (signal conductors) 2 for transmitting a differential signal, an insulation 4 collectively covering the two signal lines 2, a shield conductor 5 provided to cover the insulation 4, and ground connecting drain wires 3.

The signal line 2 is preferably formed of a solid or twisted wire formed using an electrical conductor such as copper or a plated electrical conductor, etc.

The insulation 4 desirably has small dielectric constant and dielectric loss tangent and can be formed of, e.g., polytetrafluoroethylene (PTFE), perfluoroalkoxy (PFA) or polyethylene. To further reduce dielectric constant and dielectric loss tangent, a foamed insulating resin such as foamed polyethylene or foamed Teflon may be used to form the insulation 4.

In the present embodiment, the insulation 4 is formed to have a substantially ellipsoidal shape in the cross section. The two signal lines 2 are arranged side by side in a major axis direction so that centers in the cross section are on the center line dividing the insulation 4 in a minor axis direction and are located at an equal distance from the center point of the insulation 4 (hereinafter, referred to as “cable center C”) which is the center in the major axis direction as well as in the minor axis direction. The two signal lines 2 are arranged at symmetrical positions about the cable center C (positions with 180-degree rotational symmetry).

The shield conductor 5 is formed by, e.g., winding a shielding tape having a resin layer (not shown) and a metal layer around the insulation 4. In this case, the metal layer of the shielding tape serves as the shield conductor 5. The shielding tape is spirally wound or longitudinally wrapped around the insulation 4 with the metal layer side inward. Alternatively, the shield conductor 5 may be formed of a tape-shaped metal such as copper foil (i.e., a shielding tape with no resin layer).

The drain wire 3 is preferably formed of a solid or twisted wire formed using an electrical conductor such as copper or a plated electrical conductor, etc. An example of using two drain wires 3 will be described here.

The two drain wires 3 are arranged parallel to the signal lines 2 and are located at symmetrical positions about the cable center C in the cross section. In the present embodiment, the two drain wires 3 are arranged to sandwich the two signal lines 2 from both sides in the major axis direction so that the centers thereof are aligned with the centers of the two signal lines 2 in the cross section. The signal line 2 and the drain wire 3 have the same outer diameter in this example, but may have different outer diameters.

In the high-speed transmission cable 1 of the present embodiment, the drain wire 3 is arranged so that a portion of the outer circumference (a portion in the circumferential direction) thereof covered with the insulation 4 is held by the insulation 4, another portion of the outer circumference (a portion in the circumferential direction) not covered with the insulation 4 protrudes outward from the insulation 4 and the protruding portion is electrically in contact with the shield conductor 5.

The drain wire 3 provided to protrude from the insulation 4 can be reliably in contact with the shield conductor 5. In the present embodiment, the drain wires 3 are arranged on both sides in the major axis direction, and portions of the insulation 4 at edges in the major axis direction are removed so that the drain wires 3 protrude from the insulation 4.

A protrusion length L of the drain wires 3 from the insulation 4 is smaller than a radius R of the drain wires 3. Then, a distance d between facing edges of the insulation 4 which sandwich the protruding portion of the drain wire 3 (i.e., a width of an opening of the insulation 4) is smaller than a diameter D of the drain wire 3. Thus, the drain wire 3 is held by the insulation 4 located around the protruding portion, and a state in which the drain wire 3 is held and fixed by the insulation 4 is maintained even without the shield conductor 5. Hereinafter, a portion of the insulation 4 to hold the drain wire 3 around the protruding portion is referred to as “holding piece 4a”.

The holding piece 4a is configured that an end portion in the major axis direction extends outward relative to the center of the drain wire 3 in the cross section and also extends, along the outer circumference of the drain wire 3, inward (in the drawing, downward for the upper holding piece 4a and upward for the lower holding piece 4a) relative to an edge of the drain wire 3 in the minor axis direction (the vertical direction in the drawing). In other words, the holding piece 4a is formed so that an edge thereof overlaps the drain wire 3 when viewed from a side in the major axis direction (the horizontal direction in the drawing).

If an air layer is present between the insulation 4 and the drain wire 3, electrical characteristics of the high-speed transmission cable 1 may degrade due to the air layer. Therefore, the holding piece 4a is desirably provided to be tightly in contact with the outer circumference of the drain wire 3.

Next, a method of manufacturing the high-speed transmission cable 1 will be described.

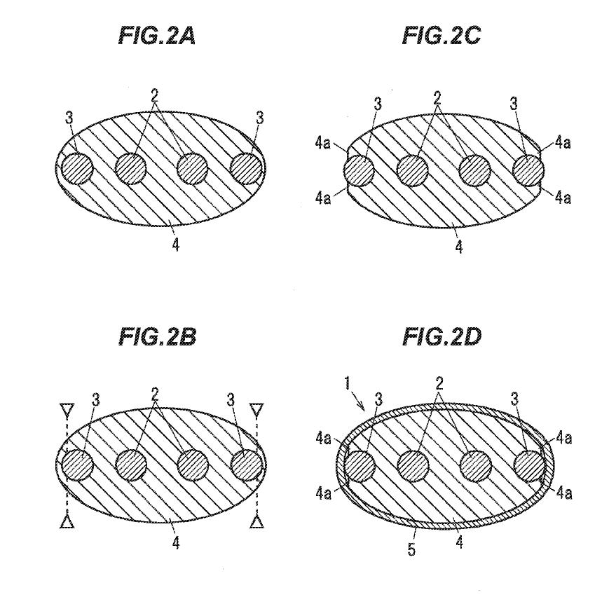

When manufacturing the high-speed transmission cable 1, firstly, extrusion molding is performed so that two signal lines 2 and two drain wires 3 are covered with one insulation 4, as shown in FIG. 2A. At this stage, the outer circumference of each drain wire 3 is covered with the insulation 4. This is a design to prevent the metal drain wire 3 from damaging a die, etc., of an extruder.

Then, as shown in FIG. 2B, a portion of the insulation 4 (both edges in the major axis direction in this example) is removed by laser beam machining. As a result, a portion of the outer circumference of each drain wire 3 protrudes outward from the insulation 4 and also the drain wires 3 are held by the holding pieces 4a, as shown in FIG. 2C.

After that, as shown in FIG. 2D, the shield conductor 5 covering the insulation 4 is provided by, e.g., winding a shielding tape around the insulation 4 so that the shield conductor 5 is electrically in contact with the protruding portions of the drain wires 3. In the present embodiment, it is easy to provide the shield conductor 5 since the drain wires 3 are held by the insulation 4. The high-speed transmission cable 1 shown in FIG. 1 is obtained through the above processes.

In the present embodiment, the two signal lines 2 and the two drain wires 3 are covered with one insulation 4. In this case, if the drain wire(s) 3 is misaligned for some reason, a die, etc., of the extruder may be damaged by the drain wire 3.

Accordingly, a resin dummy wire(s) which is less likely to damage the die, etc., may be used to manufacture the high-speed transmission cable 1 more easily. To manufacture the high-speed transmission cable 1 in this case, extrusion molding is performed using the dummy wire which is subsequently taken out, and the drain wire 3 is then fitted into a recess produced by removing the dummy wire.

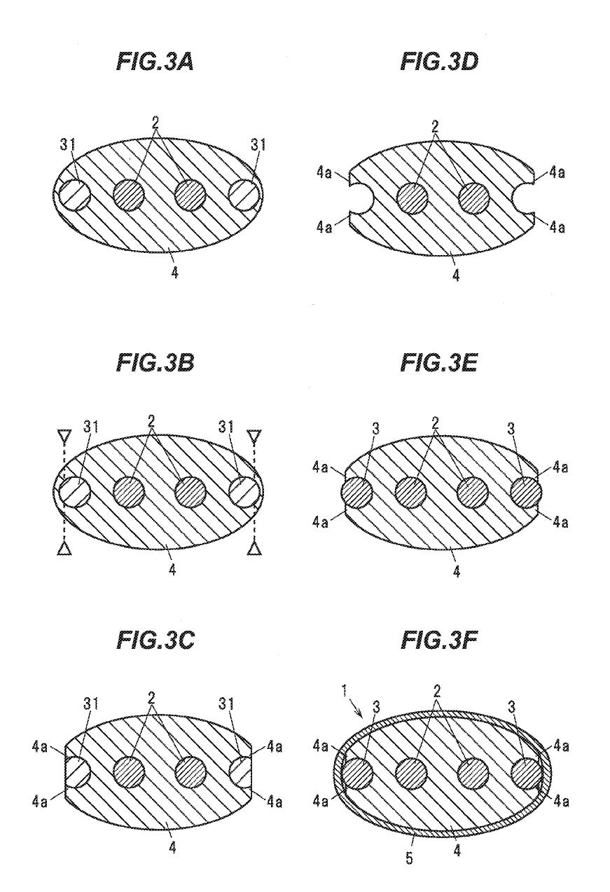

In detail, firstly, extrusion molding is performed so that two signal lines 2 and two dummy wires 31 are covered with one insulation 4, as shown in FIG. 3A. At this stage, the outer circumference of each dummy wire 31 is covered with the insulation 4. The dummy wire 31 having the same outer diameter as that of the drain wire 3 is used. In addition, the dummy wire 31 to be used is desirably formed of a resin. When the insulation 4 is formed of, e.g., foamed polyethylene, it is possible to use the dummy wire 31 formed of a non-foamed polyethylene.

Then, as shown in FIG. 3B, a portion of the insulation 4 (both edges in the major axis direction in this example) is removed by laser beam machining. At this time, the dummy wires 31 may be partially cut off. Alternatively, a method other than laser beam machining may be used to remove a portion of the insulation 4. By performing this process, the both edges of the insulation 4 in the major axis direction are removed and the holding pieces 4a are formed, as shown in FIG. 3C.

Subsequently, the dummy wires 31 are taken out as shown in FIG. 3D, and the drain wires 3 are fitted into the recesses produced by taking out the dummy wires 31 as shown in FIG. 3E. As a result, the drain wires 3 are held by the insulation 4 (the holding pieces 4a) and a portion of the outer circumference of each drain wire 3 protrudes outward from the insulation 4.

After that, as shown in FIG. 3F, the shield conductor 5 covering the insulation 4 is provided by, e.g., winding a shielding tape around the insulation 4 so that the shield conductor 5 is electrically in contact with the protruding portions of the drain wires 3. Also in this case, it is easy to provide the shield conductor 5 since the drain wires 3 are held by the insulation 4. The high-speed transmission cable 1 shown in FIG. 1 is obtained through the above processes.

Although the example of separately manufacturing each individual high-speed transmission cable 1 has been described in the present embodiment, it is also possible to manufacture plural high-speed transmission cables 1 at the same time.

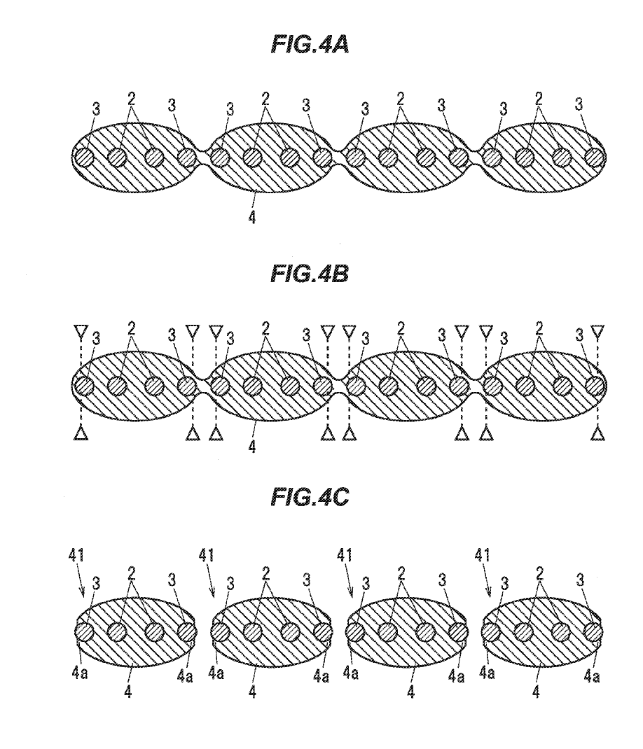

In detail, firstly, as shown in FIG. 4A, plural sets (four sets in this example) of signal lines 2 and drain wires 3 (each set consists of two signal lines 2 and two drain wires 3) are aligned in a straight line and extrusion molding is performed so that the plural sets of signal lines 2 and drain wires 3 are covered with one insulation 4.

Next, as shown in FIG. 4B, portions of the insulation 4 (portions at both edges in the major axis direction and between two adjacent sets) are removed by laser beam machining. As a result, plural cores 41, in each of which a portion of the outer circumference of each drain wire 3 protrudes outward from the insulation 4 and also the drain wires 3 are held by the holding pieces 4a, are simultaneously formed, as shown in FIG. 4C.

Then, the shield conductors 5 are respectively provided on the cores 41, thereby obtaining the high-speed transmission cables 1 of FIG. 1. Although FIGS. 4A to 4C shows an example in which the insulation 4 is provided directly on the drain wires 3, it is also possible to simultaneously form plural cores 41 through substantially the same process when using the dummy wires 31.

Functions and Effects of the Embodiment

As described above, the high-speed transmission cable 1 in the present embodiment is provided with the two parallel signal lines 2 for transmitting a differential signal, the insulation 4 collectively covering the two signal lines 2, the shield conductor 5 provided to cover the insulation 4 and the ground connecting drain wires 3, and each drain wire 3 is arranged so that a portion of the outer circumference thereof covered with the insulation 4 is held by the insulation 4, another portion of the outer circumference not covered with the insulation 4 protrudes outward from the insulation 4 and the protruding portion is electrically in contact with the shield conductor 5.

The structure of arranging the drain wire 3 to partially protrude from the insulation 4 allows the drain wire 3 to be reliably in contact with the shield conductor 5, and it is thereby possible to improve reliability. In addition, the structure of arranging the drain wire 3 to only partially protrude from the insulation 4 allows a gap between the insulation 4 and the shield conductor 5 to be minimized, and it is thereby possible to prevent degradation in electrical characteristics due to the drain wire 3.

In addition, since the drain wires 3 are held by the insulation 4, it is easy to provide the shield conductor 5 and this facilitates manufacturing of the high-speed transmission cable 1.

In other words, in the present embodiment, it is possible to realize a high-speed transmission cable with good electrical characteristics and easy to manufacture.

In addition, the high-speed transmission cable 1 can be grounded through the drain wires 3 while having a two-cores-in-one-cover structure which is suitable for high-speed transmission. In conventional high-speed transmission cables, the drain wire 3 is not used for the purpose of maintaining electrical characteristics, it is difficult to connect to a member provided on a terminal of a circuit board, etc., since removal of the cover is complicated, and this difficulty causes an increase in the cost of connection work.

According to the present embodiment, since the drain wires 3 can be provided while preventing degradation in electrical characteristics, the high-speed transmission cable 1 which is easily connected to a member provided on a terminal of a circuit board, etc., can be realized without degradation in high-speed transmission characteristics which is a distinctive feature of the two-cores-in-one-cover structure, and it is therefore possible to significantly reduce the cost of connection work. In addition, since the drain wire 3 can be connected to ground, reliability of grounding is improved.

When manufacturing the high-speed transmission cable 1, it is necessary to remove a portion of the insulation 4. This removal of the insulation 4 can be achieved by a process relatively easily implemented, such as laser beam machining, and it is thus possible to save the manufacturing cost.

In addition, in the high-speed transmission cable 1, the two drain wires 3 are arranged so that the centers thereof are aligned with the centers of the two signal lines 2 in the cross section. Therefore, when connecting to a circuit board, it is easy to fix both the drain wires 3 and the signal lines 2 on the same surface of the circuit board by soldering, etc., and this further facilitates connection work.

The high-speed transmission cable 1 is used for signal transmission between, e.g., electronic devices or between circuit boards inside an electronic device in servers, routers and data storage products, etc., which operate with high-speed digital signals of not less than several Gbps. It is also possible to use the high-speed transmission cable 1 as an active cable in which a connector having a compensation circuit is provided at an end.

Furthermore, a multipair cable can be formed by twisting plural (e.g., two pairs or eight pairs of) high-speed transmission cables 1 together.

Summary of the embodiment

Technical ideas understood from the embodiment will be described below citing the reference numerals, etc., used for the embodiment. However, each reference numeral, etc., described below is not intended to limit the constituent elements in the claims to the members, etc., specifically described in the embodiment.

[1] A high-speed transmission cable (1), comprising: two parallel signal lines (2) for transmitting a differential signal; an insulation (4) collectively covering the two signal lines (2); a shield conductor (5) provided to cover the insulation (4); and a ground connecting drain wire(s) (3), wherein the drain wire (3) is arranged so that a portion of the outer circumference thereof covered with the insulation (4) is held by the insulation (4), another portion of the outer circumference not covered with the insulation (4) protrudes outward from the insulation (4) and the protruding portion is electrically in contact with the shield conductor (5).

[2] The high-speed transmission cable (1) described in [1], wherein the insulation (4) integrally comprises holding pieces (4a) that hold the drain wire (3) around the protruding portion and fix the drain wire (3) to the insulation (4).

[3] The high-speed transmission cable (1) described in [2], wherein the holding pieces (4a) are provided so as to be tightly in contact with the outer circumference of the drain wire (3).

[4] The high-speed transmission cable (1) described in any one of [1] to [3], comprising: two of the drain wires (3), wherein the two drain wires (3) are arranged at symmetrical positions about the center (C) of the cable in the cross section.

[5] The high-speed transmission cable (1) described in [4], wherein the two drain wires (3) are arranged parallel to the signal lines (2) so that the centers thereof are aligned with the centers of the two signal lines (2) in the cross section.

[6] The high-speed transmission cable (1) described in any one of [1] to [5], wherein the shield conductor (5) comprises a metal layer that constitutes, together with a resin layer, a shielding tape, and the shielding tape is wound around the insulation (4) with the metal layer side inward.

[7] A method of manufacturing a high-speed transmission cable (1), comprising: covering two parallel signal lines (2) for transmitting a differential signal and a ground connecting drain wire(s) (3) with an insulation (4); removing a portion of the insulation (4) so that a portion of the outer circumference of the drain wire(s) (3) protrudes outwards from the insulation (4); and providing a shield conductor (5) to cover the insulation (4) so that the shield conductor (5) is electrically in contact with the protruding portion(s) of the drain wire(s) (3).

[8] A method of manufacturing a high-speed transmission cable (1), comprising: covering two parallel signal lines (2) for transmitting a differential signal and a dummy wire(s) (31) with an insulation (4); removing a portion of the insulation (4) and taking the dummy wire(s) (31) out from the insulation (4); fitting a ground connecting drain wire(s) (3) into a recess(es) on the insulation (4) produced by taking out the dummy wire(s) (31) so that the drain wire(s) (3) is held by the insulation (4) and also a portion of the outer circumference of the drain wire(s) (3) protrudes outwards from the insulation (4); and providing a shield conductor (5) to cover the insulation (4) so that the shield conductor (5) is electrically in contact with the protruding portion(s) of the drain wire(s) (3).

[9] The method described in [8], wherein the dummy wire (31) having the same outer diameter as that of the drain wire (3) is used.

[10] The method described in [8] or [9], wherein the dummy wire (31) comprising a resin is used.

Although the embodiment of the invention has been described, the invention according to claims is not to be limited to the embodiment. Further, please note that all combinations of the features described in the embodiment are not necessary to solve the problem of the invention.

The invention can be appropriately modified and implemented without departing from the gist thereof.

For example, although the example of using two drain wires 3 has been described in the embodiment, one of the drain wires 3 may be omitted, i.e., the number of the drain wires 3 may be one.

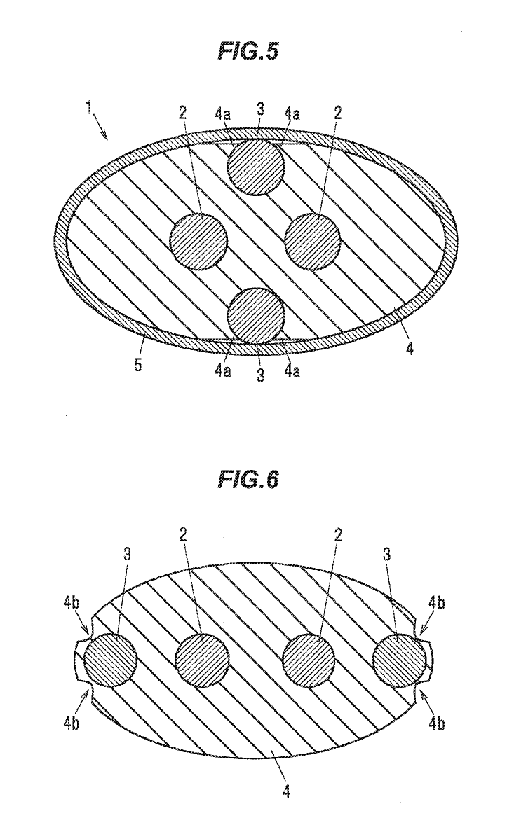

In addition, although the two signal lines and the two drain wires 3 are aligned in a line in the embodiment, it is not limited thereto. For example, as shown in FIG. 5, the drain wires 3 may be arranged on both edges in the minor axis direction (upper and lower edges in the drawing) so as to be aligned in a vertical direction (the minor axis direction) orthogonal to an alignment direction of the two signal lines (the major axis direction).

In addition, to facilitate removal of the insulation 4 by laser beam machining, portions of the insulation 4 to be laser machined may be formed as thin portions 4b at the stage of extrusion molding as shown in FIG. 6, even though it is not mentioned in the embodiment. In this case, the narrow portions 4b are exposed to a laser beam to remove the insulation 4.

What is claimed is:

1. A high-speed transmission cable, comprising:
two parallel signal lines for transmitting a differential signal;
an insulation collectively covering the two signal lines;
a shield conductor covering the insulation; and
a ground connecting drain wire,
wherein the drain wire is arranged so that a portion of the outer circumference thereof covered with the insulation is held by the insulation, another portion of the outer circumference not covered with the insulation protrudes outward from the insulation and the protruding portion is electrically in contact with the shield conductor.

2. The high-speed transmission cable according to claim 1, wherein the insulation integrally comprises a holding piece that holds the drain wire around the protruding portion and fix the drain wire to the insulation.

3. The high-speed transmission cable according to claim 2, wherein the holding piece is provided so as to be tightly in contact with the outer circumference of the drain wire.

4. The high-speed transmission cable according to claim 1, wherein the drain wire comprises two drain wires, and
wherein the two drain wires are arranged at symmetrical positions to a center of the cable in a cross section.

5. The high-speed transmission cable according to claim 4, wherein the two drain wires are arranged parallel to the signal lines so that a center thereof is aligned with a center of the two signal lines in the cross section.

6. The high-speed transmission cable according to claim 1, wherein the shield conductor comprises a metal layer of a shielding tape comprising a resin layer and the metal layer, and
wherein the shielding tape is wound around the insulation with the metal layer side faced inward.

7. A method of manufacturing a high-speed transmission cable, comprising:
covering two parallel signal lines for transmitting a differential signal and a ground connecting drain wire with an insulation;
removing a portion of the insulation so that a portion of the outer circumference of the drain wire protrudes outwards from the insulation; and
providing a shield conductor to cover the insulation so that the shield conductor is electrically in contact with the protruding portion of the drain wire.

8. A method of manufacturing a high-speed transmission cable, comprising:
covering two parallel signal lines for transmitting a differential signal and a dummy wire with an insulation;
removing a portion of the insulation and taking the dummy wire out from the insulation;
fitting a ground connecting drain wire into a recess on the insulation produced by taking out the dummy wire so that the drain wire is held by the insulation and a portion of the outer circumference of the drain wire protrudes outwards from the insulation; and
providing a shield conductor to cover the insulation so that the shield conductor is electrically in contact with the protruding portion of the drain wire.

9. The method according to claim 8, wherein the dummy wire having a same outer diameter as that of the drain wire is used.

10. The method according to claim 8, wherein the dummy wire comprising a resin is used.
